(19) United States
(12) Patent Application Publication
(10) Pub. No.: US 2006/0227267 A1
(43) Pub. Date: Oct. 12, 2006

(54) Substrate for semi-transmitting type liquid crystal display element and semi-transmitting type liquid crystal display element including the substrate

(75) Inventors: Masahiro Ikadai, Mie-ken (JP); Etsuo Ogino, Ryugasaki-shi (JP)

Correspondence Address: COHEN, PONTANI, LIEBERMAN & PAVANE, 551 FIFTH AVENUE, SUITE 1210, NEW YORK, NY, 10176, US

(73) Assignee: Nippon Sheet Glass Company, Limited, Tokyo (JP)

(21) Appl. No.: 11/400,901

(22) Filed: Apr. 10, 2006

(30) Foreign Application Priority Data
Apr. 11, 2005 (JP) 2005-113495

(51) Int. Cl. G02F 1/1335

(52) U.S. Cl. 349/114

(57) ABSTRACT

A substrate for a semi-transmitting type liquid crystal display element, which is capable of suppressing occurrence of display non-uniformity of the semi-transmitting type liquid crystal display element. A reflective mirror is formed by alternately forming in layers at least one first transparent dielectric film and at least one second transparent dielectric film on a transparent substrate. The first and second transparent dielectric films are different in refractive index from each other. The reflective mirror is formed between a liquid crystal section of the semi-transmitting type liquid crystal display element and the transparent substrate, and the first transparent dielectric film is made of a substantially photocatalytically inactive compound.

### BACKGROUND OF THE INVENTION

1. Field of the Invention

The present invention relates to a substrate for a semi-transmitting type liquid crystal display element, and a semi-transmitting type liquid crystal display element including the substrate, and more particularly to a substrate for a semi-transmitting type liquid crystal display element, which includes a reflective mirror formed by alternately forming in layers two transparent dielectric films different from one another in refractive index, and a semi-transmitting type liquid crystal display element including the substrate.

2. Description of the Related Art

As a liquid crystal display element used in the display section of a cellular phone, there has been conventionally proposed a semi-transmitting (semi-transmissive/transreflective) type liquid crystal display element which is comprised of a back light, a multilayer film formed by transparent dielectric films, and a color filter (color pigments) formed on the multilayer film (see e.g. Publication of Japanese Patent No. 3255638).

When the back light is not used, the semi-transmitting type liquid crystal display element has proper reflectance due to the provision of the multilayer film, and is capable of providing sufficient display under sunlight or fluorescent light while suppressing power consumption, whereas when the back light is used, it has appropriate transmittance.

The multilayer film comprises a reflective mirror formed by high-refractive-index transparent films and low-refractive-index transparent films that are alternately formed in layers on a glass substrate. Titanium dioxide (TiO₂), which has a hydrophobic property and becomes photocatalytically active when irradiated with ultraviolet rays, is often used as a material of the high-refractive-index transparent films. Further, silicon dioxide (SᵢO₂) is often used as a material of the low-refractive-index transparent films. Since titanium dioxide of the multilayer film is photocatalytically active, by irradiating ultraviolet rays onto titanium dioxide before the color filter is formed on the multilayer film, organic matters on the surface of the multilayer film can be decomposed to thereby eliminate the organic matters easily.

Further, there has been conventionally proposed a reflecting-type liquid crystal display element which is comprised of a reflection increasing film formed by a multilayer transparent dielectric film, a reflection film made of metal and formed on the reflection increasing film, and a color filter (color pigments) formed on the reflection film and of which reflectance for light with wavelengths of 400 to 800 nm is set to not less than 90% (see e.g. Japanese Laid-Open Patent Publication (Kokai) No. 2004-78204).

However, since titanium dioxide used for a multilayer film of a semi-transmitting type liquid crystal display element has a hydrophobic property, the multilayer film is not suitable for being washed with a water-soluble washing liquid. In view of this, it is demanded that a hydrophilic film with a film thickness of not more than 10 nm be formed on the outermost surface of the multilayer film (see Publication of Japanese Patent No. 3255638 (Paragraph number [0045])).

Further, titanium dioxide, which is photocatalytically active, brings about the following problems: upon reception of light, a wetting property thereof can be changed into a high degree of hydrophilic property; a large interaction can occur between titanium dioxide and materials in contact therewith adversely influences affinity and adhesiveness; and organic matters constituting resin components forming the materials in contact with titanium dioxide are decomposed and deteriorated (chalking). These result in the degraded adhesiveness between the titanium dioxide film and a glass substrate in contact with the underside surface of the titanium dioxide film and between the titanium dioxide film and the color pigments formed on the top surface of the titanium dioxide film.

The above-described resin components include a photo lithography resist applied to titanium dioxide. When the wetting property of the resist is made unstable by the photocatalytic activity of titanium dioxide, or when the adhesiveness between the resist and the titanium dioxide layer is lowered by decomposition of the resist, it is impossible to ensure homogeneity of a resist pattern for use in the patterning process of the multilayer film.

Moreover, since titanium dioxide has the photocatalytic activity, photo-induced charge separation is caused by ultraviolet rays contained in the back light, which results in occurrence of display non-uniformity of the liquid crystal display element.

In the above-described reflecting-type liquid crystal display element, on the other hand, stray capacity, which is large and stable, is generated in the reflection film made of metal. Therefore, even when photocatalytically active titanium dioxide is used, adverse influence of the photo-induced charge separation occurring in titanium dioxide, that is, the display non-uniformity of the liquid crystal display element falls within tolerance. However, the reflection film made of metal must be formed on the reflection increasing film.

### SUMMARY OF THE INVENTION

It is an object of the present invention to provide a substrate for a semi-transmitting type liquid crystal display element, which is capable of suppressing occurrence of display non-uniformity of the semi-transmitting type liquid crystal display element, and a semi-transmitting type liquid crystal display element including the substrate.

To attain the above object, in a first aspect of the present invention, there is provided a substrate for a semi-transmitting type liquid crystal display element, comprising a transparent substrate, and a reflective mirror formed by alternately forming in layers at least one first transparent dielectric film and at least one second transparent dielectric film on the transparent substrate, the first and second transparent dielectric films being different in refractive index from each other, wherein the reflective mirror is formed between a liquid crystal section of the semi-transmitting type liquid crystal display element and the transparent substrate, and the first transparent dielectric film is made of a substantially photocatalytically inactive compound.

With the arrangement of the substrate for a semi-transmitting type liquid crystal display element, according to the first aspect of the invention, at least one first transparent dielectric film of a reflective mirror formed between a liquid crystal section of a semi-transmitting type liquid crystal display element and a transparent substrate is made of a substantially photocatalytically inactive compound. Therefore, it is possible to suppress occurrence of display non-uniformity of the semi-transmitting type liquid crystal display element.

Preferably, the compound comprises niobium oxide.

With the arrangement of this preferred embodiment, the compound forming the first transparent dielectric film comprises niobium oxide. Therefore, it is possible to more positively suppress occurrence of the display non-uniformity.

More preferably, the niobium oxide comprises niobium pentoxide or an oxygen-deficient form thereof.

With the arrangement of this preferred embodiment, the niobium oxide comprises niobium pentoxide (Nb₂O₅) or an oxygen-deficient form thereof. Therefore, it is possible to more positively suppress occurrence of display non-uniformity.

More preferably, the niobium oxide has a refractive index in a range of 2.2 to 2.5 for light with wavelengths of 400 to 800 nm.

With the arrangement of this preferred embodiment, the niobium oxide has a refractive index in a range of 2.2 to 2.5 for light with wavelengths of 400 to 800 nm. Therefore, it is possible to positively increase the difference between the refractive index of the first transparent dielectric film and that of the second transparent dielectric film.

Preferably, the first transparent dielectric film has a higher refractive index for light with wavelengths of 400 to 800 nm than that of the second transparent dielectric film, and a most remote surface of the reflective mirror from the transparent substrate is made of the first transparent dielectric film.

With the arrangement of this preferred embodiment, the most remote surface of the reflective mirror from the transparent substrate is formed by the first transparent dielectric film having a higher refractive index than that of the second transparent dielectric film. Therefore, it is possible to improve adhesiveness between the reflective mirror and materials formed on the reflective mirror, such as color pigments of the semi-transmitting type liquid crystal display element.

Preferably, the first transparent dielectric film has a higher refractive index for light with wavelengths of 400 to 800 nm than that of the second transparent dielectric film, said first transparent dielectric film being in contact with the transparent substrate.

With the arrangement of this preferred embodiment, the transparent substrate is in contact with the first transparent dielectric film having a higher refractive index than that of the second transparent dielectric film. Therefore, it is possible to improve adhesiveness between the reflective mirror and the transparent substrate.

Preferably, the first and second transparent dielectric films of the reflective mirror are formed in three or four layers, and the reflective mirror has optical characteristics that transmittance thereof for light with wavelengths in a visible light region is not less than 80%, and reflectance thereof for the light is not more than 20%.

With the arrangement of this preferred embodiment, the reflective mirror comprised of the first and second transparent dielectric films that are formed in three or four layers has optical characteristics that transmittance thereof for light with wavelengths in a visible light region is not less than 80%, and reflectance thereof for the light is not more than 20%. Therefore, it is possible to suppress occurrence of display non-uniformity when the reflective mirror receives light with wavelengths in the visible light region.

Preferably, the first and second transparent dielectric films of the reflective mirror are formed in five or six layers, and the reflective mirror has optical characteristics that transmittance thereof for light with wavelengths of 400 to 600 nm is 60 to 75% and reflectance thereof for the light is 25 to 40%, and that transmittance thereof for light with wavelengths of 600 to 750 nm is 60 to 85% and reflectance thereof for the light is 15 to 40%.

Preferably, the first and second transparent dielectric films of the reflective mirror are formed in seven to fourteen layers, and the reflective mirror has optical characteristics that transmittance thereof for light with wavelengths of 400 to 600 nm is 55 to 70% and reflectance thereof for the light is 30 to 45%, and that transmittance thereof for light with wavelengths of 600 to 750 nm is 55 to 80% and reflectance thereof for the light is 20 to 45%.

To attain the above object, in a second aspect of the present invention, there is provided a semi-transmitting type liquid crystal display element, comprising the substrate for a semi-transmitting type liquid crystal display element, according to the first aspect of the present invention, and color pigments formed on the reflective mirror, wherein the liquid crystal section is formed on the color pigments.

With the arrangement of the semi-transmitting type liquid crystal display element according to the second aspect of the invention, the element is comprised of the substrate according to the first aspect, color pigments formed on the reflective mirror, and the liquid crystal section formed on the color pigments. This makes it possible to suppress occurrence of display non-uniformity.

Preferably, the first transparent dielectric film has a higher refractive index for light with wavelengths of 400 to 800 nm than that of the second transparent dielectric film, the first transparent dielectric film being in contact with the color pigments.

With the arrangement of this preferred embodiment, the first transparent dielectric film having a higher refractive index than that of the second transparent dielectric film is in contact with the color pigments. Therefore, it is possible to improve adhesiveness between the reflective mirror and the color pigments.

Preferably, the semi-transmitting type liquid crystal display element is formed either as a semi-transmitting type liquid crystal display element in which reflectance thereof for light with wavelengths of 400 to 800 nm is set to a range of 45 to 80%, or as a transmitting type liquid crystal display element in which reflectance thereof for the light with wavelengths of 400 to 800 nm is set to a range of 5 to 45%.

The above and other objects, features, and advantages of the invention will become more apparent from the following detailed description taken in conjunction with the accompanying drawings.

### BRIEF DESCRIPTION OF THE DRAWINGS

FIG. 1 is a schematic sectional view of a semi-transmitting type liquid crystal display element according to an embodiment of the present invention;

FIG. 2 is a detailed cross-sectional view of the substrate shown in FIG. 1;

FIG. 3 is a graph showing the relationship between light wavelength and light transmittance of the substrate shown in FIG. 2; and

FIG. 4 is a graph showing the relationship between light wavelength and light reflectance of the substrate shown in FIG. 2.

### DETAILED DESCRIPTION OF THE PREFERRED EMBODIMENTS

The present inventors carried out assiduous studies to attain the above object, and as a result, discovered that in the case of a substrate for a semi-transmitting type liquid crystal display element, including a transparent substrate, and a reflective mirror formed by alternately forming in layers at least one first transparent dielectric film and at least one second transparent dielectric film on the transparent substrate, where the films are different from one another in refractive index, if the at least one first transparent dielectric film of the reflective mirror formed between a liquid crystal section of the semi-transmitting type liquid crystal display element and the transparent substrate is made of a substantially photocatalytically inactive compound, it is possible to suppress occurrence of display non-uniformity of the semi-transmitting type liquid crystal display element.

The present invention has been made based on the results of the above-described studies.

An embodiment of the present invention will now be described in detail with reference to the drawings.

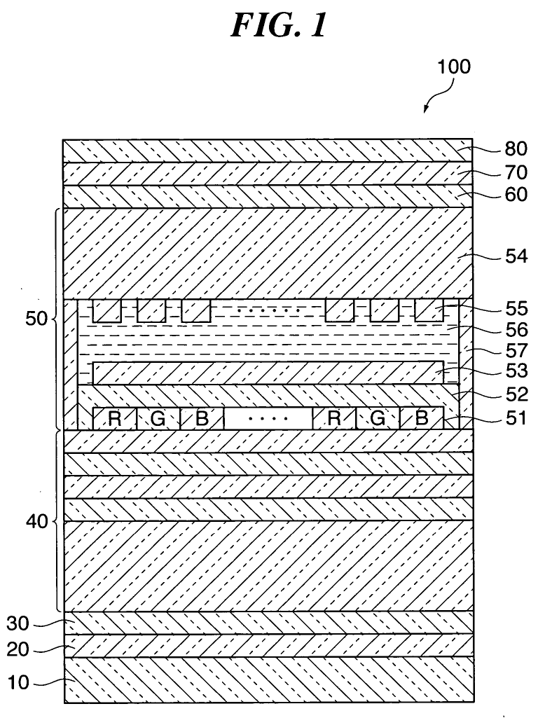

FIG. 1 is a schematic cross-sectional view of the semi-transmitting type liquid crystal display element according to the embodiment.

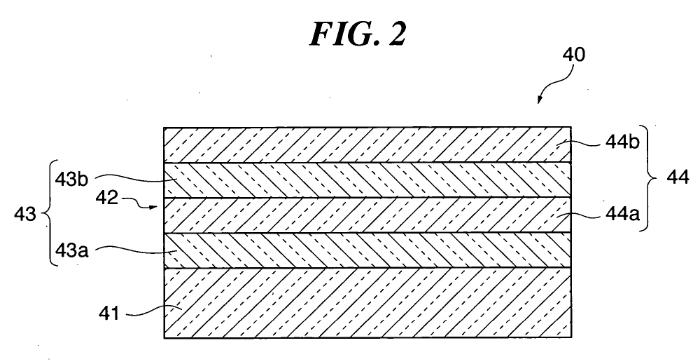

The semi-transmitting type liquid crystal display element 100 according to the present embodiment is comprised of a back light 10, a polarizing plate 20, a phase contrast plate 30, a substrate 40 for the semi-transmitting type liquid crystal display element, described hereinafter with reference to FIG. 2, a liquid crystal section 50, a diffusing plate 60, a phase contrast plate 70, and a polarizing plate 80, which are formed in layers in the mentioned order from below as viewed in FIG. 1. The semi-transmitting type liquid crystal display element 100 has light reflectance that is set in a range of 45 to 80%, wherein the reflectance is measured for light with wavelengths of 400 to 800 nm in a visible light region, irradiated on one surface of the liquid crystal display element 100 at an incidence angle of 0° (hereinafter simply referred to as “reflectance”).

It should be noted that the reflectance (%) designates a ratio of reflection of light that has a wavelength of 400 to 800 nm in a visible light region including a wavelength of 640 nm corresponding to red, a wavelength of 530 nm corresponding to green, and a wavelength of 460 nm corresponding to blue, and the transmittance (%) designates a ratio of transmission of light with wavelengths of 400 to 750 nm in the visible light region including the wavelength of 640 nm corresponding to red, the wavelength of 530 nm corresponding to green, and the wavelength of 460 nm corresponding to blue.

The liquid crystal section 50 is comprised of color pigments 51 formed by red, green, and blue cells arranged mosaically on a dielectric multilayer film reflective mirror, an overcoat 52 for protecting the color pigments 51, a transparent electrically conductive film 53 made of ITO (Indium-Tin Oxide), a transparent substrate 54, a plurality of transparent electrically conductive films 55 made e.g. of ITO, formed on the lower surface of the transparent substrate 54, a liquid crystal layer 56 made of a liquid crystal having a refractive index for light with a wavelength of 550 nm (hereinafter simply referred to as “the refractive index”) in a range of 1.50 to 1.52, and sandwiched by the transparent electrically conductive film 53 and a plurality of transparent electrically conductive films 55, and a sealing member 57 disposed around the liquid crystal layer 56 such that the liquid crystal is prevented from leaking to the outside.

FIG. 2 is a detailed cross-sectional view of the substrate 40 for the semi-transmitting type liquid crystal display element, appearing in FIG. 1.

The substrate 40 for the semi-transmitting type liquid crystal display element is comprised of a transparent substrate 41 formed on the phase contrast plate 30 appearing in FIG. 1, and a reflective mirror 42 formed on the transparent substrate 41, as shown in FIG. 2. This means that the reflective mirror 42 is formed between the transparent substrate 41 and the liquid crystal section 50.

The transparent substrate 41 is made of a soda lime silicate glass having a refractive index in a range of approximately 1.53 to 1.55. The transparent substrate 41 may be made of a silica glass, a silicate-based glass, a no-alkali glass, such as an “NA 35 glass” (commodity name) manufactured by NH Techno Glass Corp., or an “AN glass” (commodity name) manufactured by Asahi Glass Co. Ltd., a low-alkali glass, a transparent plastic substrate, or the like.

The reflective mirror 42 is formed by a dielectric multilayer film comprised of a predetermined number m (m is a positive integer) of layers, e.g. four layers of a dielectric material small in light absorption. The dielectric multilayer film is formed by depositing e.g. two pairs of layers, each pair made of a high-refractive-index transparent film 43a or 43b of a high-refractive-index material and a low-refractive-index transparent film 44a or 44b of a low-refractive-index material, and functions as a reflective film for reflecting light. Hereinafter, one or both of the high-refractive-index transparent films 43a and 43b are sometimes referred to by reference numeral 43, and one or both of the low-refractive-index transparent films 44a and 44b are sometimes referred to by reference numeral 44. The dielectric multilayer film is more suitable as the difference in refractive index between the high-refractive-index transparent film 43 and the low-refractive-index transparent film 44 is larger.

The high-refractive-index transparent films 43 are formed by a high-refractive-index transparent film 43a that has a thickness of e.g. 63.9 nm and is formed on the transparent substrate 41 and a high-refractive-index transparent film 43b that has a thickness of e.g. 5.7 nm and is sandwiched between the two low-refractive-index transparent films 44.

The high-refractive-index material forming the high-refractive-index transparent films 43a and 43b comprises a dielectric compound whose photocatalytic property is substantially inert. This makes it possible to suppress occurrence of display non-uniformity of the semi-transmitting liquid crystal display element 100 caused by photo-induced charge separation occurring in the liquid crystal display element 100 when the dielectric compound receives ultraviolet rays or the like.

As the substantially photocatalytically inactive dielectric compound, it is possible to use niobium pentoxide (Nb₂O₅) having a refractive index in a range of 2.2 to 2.5, and an oxygen-deficient form of niobium pentoxide having a refractive index in a range of 2.2 to 2.5. Niobium pentoxide containing no impurities, highly purified, and having few defects is easily available, and hence it is possible to reduce defects produced within the formed high-refractive-index transparent films 43a and 43b.

From the above, since no compound having a high photocatalytic activity, such as titanium dioxide, is used as the high-refractive-index material, it is possible to lessen interactions between the high-refractive-index transparent films 43a and 43b, and resin components as materials in contact with the films 43a and 43b, whereby affinity and adhesiveness of the films 43a and 43b to the resin components can be improved.

Further, the low-refractive-index transparent films 44 are formed by a low-refractive-index transparent film 44a that has a thickness of e.g. 52.3 nm and is formed on the high-refractive-index transparent film 43a, and a low-refractive-index transparent film 44b that has a thickness of e.g. 12.0 nm and is formed on the high-refractive-index transparent film 43b. The color pigments 51 are formed on the low-refractive-index transparent film 44b.

The low-refractive-index material for forming the low-refractive-index transparent films 44a and 44b comprises silicon dioxide (SᵢO₂) having a refractive index in a range of 1.45 to 1.46. Since silicon dioxide containing no impurities, highly purified, and having few defects is easily available, it is possible to reduce defects produced within the high-refractive-index transparent films 43a and 43b.

It should be noted that the low-refractive-index material is not limited to silicon dioxide, but any suitable dielectric material can be used insofar as its photocatalytic property is substantially inert. As a result, it is possible to refrain from using a compound having a high photocatalytic activity as the low-refractive-index material, and therefore it is possible not only to suppress display non-uniformity of the liquid crystal display element 100 caused by photo-induced charge separation occurring therein when the compound having high photocatalytic activity receives ultraviolet rays or the like but also to lessen interactions between the low-refractive-index transparent films 44a and 44b, and the resin components as the materials in contact with the films 44a and 44b, whereby affinity and adhesiveness of the films 44a and 44b to the resin component can be improved.

Further, it is preferable that the low-refractive-index material has a refractive index of not more than 1.5. This makes it possible to positively increase the difference between the refractive index of the high-refractive-index transparent films 43 and that of the low-refractive-index transparent films 44. The low-refractive-index material may contain a small amount of aluminum oxide, which makes it possible to reduce the distortion of the multilayer film when the low-refractive-index transparent films 44 are formed alternately with the high-refractive-index transparent films 43 to form the multilayer film, and enhance chemical durability of the same.

The transmittance and the reflectance of the reflective mirror 42 are set to desired values by appropriately changing the thicknesses of the high-refractive-index transparent films 43 and the low-refractive-index transparent films 44, and the value of the above-described number m of the layers of the films 43 and 44, as required.

It is preferable that the value of the number m of the layers is in a range of 3 to 14. By setting the number m of the layers to a small value e.g. between 3 and 4, it is possible to shorten a time period required for forming the layers to enhance mass productivity. By increasing the value of the number m of the layers, it is possible to further enhance the effect of preventing the light from being colored when reflected from the reflective mirror 42. Furthermore, if the value of the number m of the layers is not smaller than 6, it is possible to make the reflectance curve flatter to thereby further increase the coloring-preventing effect. This is more preferable. It should be noted that if the value of the number m of the layers is larger than 12, it is difficult to enhance mass productivity. Therefore, it is preferable that the value is not larger than 12.

Further, although the film thicknesses of the high-refractive-index transparent films 43 and the low-refractive-index transparent films 44 are progressively decreased on a film-by-film basis as the distance from the transparent substrate 41 is larger, this is not limitative, but the thicknesses of the films 43 and 44 may be progressively increased on a film-by-film basis as the distance from the transparent substrate 41 is larger, or only the thicknesses of the films 43 may be progressively increased or decreased on a film-by-film basis as the distance from the transparent substrate 41 is larger. Further, only the thicknesses of the films 44 may be progressively increased or decreased on a film-by-film basis as the distance from the transparent substrate 41 is larger. By arranging the high-refractive-index transparent films 43 and the low-refractive-index transparent films 44 as described above, it is possible to reduce the difference between the maximum value and the minimum value of the reflectance of the reflective mirror 42 in the visible light region to realize a desired flat optical characteristic, thereby making it possible to prevent the light from being colored when reflected from the reflective mirror 42.

Hereinafter, a detailed description will be given of a method of forming the high-refractive-index transparent films 43 and the low-refractive-index transparent films 44.

In the present film-forming method, an inline sputtering system, for example, is used, and niobium pentoxide and silicon dioxide are alternately deposited on the transparent substrate 41 to thereby form the high-refractive-index transparent films 43 and the low-refractive-index transparent films 44, respectively. A carrousel-type sputtering system may also be employed. As targets of the sputtering system, electrically conductive niobium pentoxide and silica glass are used.

Further, niobium pentoxide forming the high-refractive-index transparent films 43 by the film-forming method is deposited as an oxygen-deficient form, and hence the value of the refractive index of this form of niobium pentoxide can be made higher than that of niobium pentoxide which is not deficient in oxygen, whereby it is possible to increase the difference between the refractive index of niobium pentoxide and that of silicon dioxide. This makes it possible to easily impart a desired optical characteristic to the reflective mirror 42 without the requirements of making film thicknesses thicker than required and making the value of the number m of the layers larger than normally required, which would otherwise bring about limitations in optical design, thereby making it possible to improve manufacturing efficiency.

More specifically, by using the inline sputtering system, and under predetermined film-forming conditions, by forming the high-refractive-index transparent film 43a on the transparent substrate 41, forming the low-refractive-index transparent films 44a on the high-refractive-index transparent film 43a, forming the high-refractive-index transparent film 43b on the low-refractive-index transparent films 44a, and forming the low-refractive-index transparent films 44b on the high-refractive-index transparent film 43b, the substrate 40 for the semi-transmitting type liquid crystal display element is manufactured which includes a multilayer film comprised of layers the number m of which is 4.

Specimens of the substrate 40 for the semi-transmitting type liquid crystal display element are produced e.g. as follows:

First of all, soda lime glass with a size of 370 mm×300 mm×0.7 mm (thickness), which contains 72 mass % of SiO₂, 13 mass % of Na₂O, 8 mass % of CaO, 1.8 mass % of Al₂O₃, and 0.9 mass % of K₂O, as main components, is used as the transparent substrate.

Then, a reflective mirror is formed on the transparent substrate using the inline sputtering system e.g. by a film-forming method, described below. Film-forming conditions of the sputtering system are as follows: The transfer speed of the transparent substrate 41 is 0.2 m/min, a film-forming temperature in Transfer S31 is 200 degrees centigrade, and a film-forming temperature in Buffer S41 is 250 degrees centigrade. One or a plurality of targets of 60 cm×12 cm are used in the sputtering system. Conductive niobium pentoxide is used to form the high-refractive-index transparent films 43a and 43b, and silica glass is used to form the low-refractive-index transparent films 44a and 44b.

Subsequently, a matching layer formed by an imaginary layer, which is optically equivalent to the liquid crystal section 50, and whose refractive index is in a range of 1.50 to 1.60, e.g. 1.52, is formed on the reflective mirror.

In the substrate 40 for the semi-transmitting type liquid crystal display element, which includes a multilayer film comprised of layers the number m of which is 4, the high-refractive-index transparent film 43a as a first layer of the reflective mirror 42 is formed using a conductive niobium pentoxide target having a resistance value of approximately 1 Ωcm, by applying a direct current (DC) having a power density of 41.6 kW/m² to the target, under a processing atmosphere in which a flow rate ratio between argon (Ar) and oxygen (O₂) is Ar:O₂=184 sccm: 6 sccm, and a film-forming pressure is 0.6 Pa. The film thickness of the high-refractive-index transparent film 43a thus obtained is 63.9 nm, for example. It should be noted that niobium pentoxide thus obtained is an oxygen-deficient form which is slightly oxygen deficient with respect to the stoichiometric composition (Nb₂O₅).

Then, the low-refractive-index transparent film 44a as a second layer of the reflective mirror 42 is formed using four quartz targets of silicon dioxide, by applying a DC having a power density of 15.6 kW/m² to the target, under a processing atmosphere in which the flow rate ratio is Ar:O₂₌₆₄ sccm: 52 sccm, and the film-forming pressure is 0.4 Pa. The thickness of the low-refractive-index transparent film 44a thus obtained is 52.3 nm, for example.

The high-refractive-index transparent film 43b as a third layer of the reflective mirror 42 is formed using a conductive niobium pentoxide target similar to the above-mentioned niobium pentoxide target, by applying a DC having a power density of 12.7 kW/m² to the target, under a processing atmosphere in which the flow rate ratio is Ar:O₂₌₃₁₅ sccm: 10 sccm, and the film-forming pressure is 1.1 Pa. The thickness of the high-refractive-index transparent film 43b thus obtained is 5.7 nm, for example.

The low-refractive-index transparent film 44b as a fourth layer of the reflective mirror 42 is formed using two quartz targets similar to the above-mentioned quartz targets, by applying a DC having a power density of 6.9 kW/m² to the target, under a processing atmosphere in which the flow rate ratio is Ar:O₂₌₁₆₈ sccm: 137 sccm, and the film-forming pressure is 1.1 Pa. The thickness of the low-refractive-index transparent film 44b thus obtained is 12.0 nm, for example.

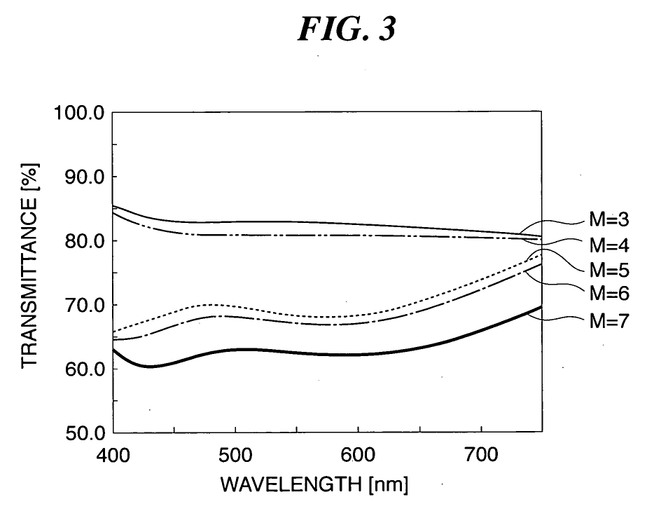

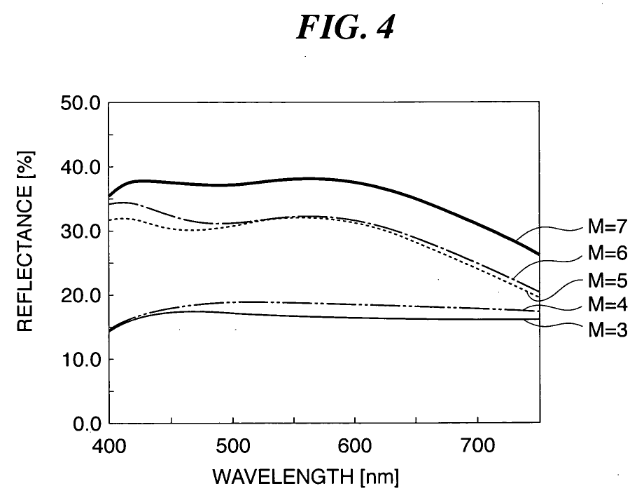

Further, examples of similarly manufactured substrates 40 each including a multilayer film comprised of layers the number m of which is in a range of 3 to 7 are shown together with film-forming conditions therefor and film thicknesses thereof in Table 1 and FIGS. 3 and 4.

TABLE 1

| | | | | | O₂ | | Power | Film |
|---|---|---|---|---|---|---|---|---|
| Number of | | Targets | Ar | O₂ | Concentration | Pressure | Density | Thickness |
| Layers M | Material | (Number) | (sccm) | (sccm) | (%) | (Pa) | (kW/m²) | (nm) |
| 3 | Nb₂O₅ | 1 | 184 | 6 | 3 | 0.6 | 51.0 | 78.4 |
| | SiO₂ | 4 | 64 | 52 | 45 | 0.4 | 14.1 | 47.2 |
| | Nb₂O₅ | 1 | 315 | 10 | 3 | 1.1 | 23.2 | 10.4 |
| 4 | Nb₂O₅ | 1 | 184 | 6 | 3 | 0.6 | 41.6 | 63.9 |
| | SiO₂ | 4 | 64 | 52 | 45 | 0.4 | 15.6 | 52.3 |
| | Nb₂O₅ | 1 | 315 | 10 | 3 | 1.1 | 12.7 | 5.7 |
| | SiO₂ | 2 | 168 | 137 | 45 | 1.1 | 6.9 | 12.0 |
| 5 | Nb₂O₅ | 1 | 184 | 6 | 3 | 0.6 | 48.0 | 73.7 |
| | SiO₂ | 4 | 64 | 52 | 45 | 0.4 | 16.6 | 55.7 |
| | Nb₂O₅ | 1 | 315 | 10 | 3 | 1.1 | 112.5 | 50.4 |
| | SiO₂ | 2 | 168 | 137 | 45 | 1.1 | 16.5 | 28.8 |
| | Nb₂O₅ | 1 | 315 | 10 | 3 | 1.1 | 45.3 | 20.3 |
| 6 | Nb₂O₅ | 1 | 184 | 6 | 3 | 0.6 | 48.0 | 73.8 |
| | SiO₂ | 4 | 64 | 52 | 45 | 0.4 | 16.8 | 56.2 |
| | Nb₂O₅ | 1 | 315 | 10 | 3 | 1.1 | 114.5 | 51.3 |
| | SiO₂ | 2 | 168 | 137 | 45 | 1.1 | 17.1 | 29.8 |
| | Nb₂O₅ | 1 | 315 | 10 | 3 | 1.1 | 46.2 | 20.7 |
| | SiO₂ | 2 | 168 | 137 | 45 | 1.1 | 16.5 | 28.7 |
| 7 | Nb₂O₅ | 1 | 184 | 6 | 3 | 0.6 | 38.0 | 58.4 |
| | SiO₂ | 4 | 64 | 52 | 45 | 0.4 | 24.4 | 81.9 |
| | Nb₂O₅ | 1 | 315 | 10 | 3 | 1.1 | 120.7 | 54.1 |
| | SiO₂ | 2 | 168 | 137 | 45 | 1.1 | 6.2 | 10.8 |
| | Nb₂O₅ | 1 | 315 | 10 | 3 | 1.1 | 38.2 | 17.1 |
| | SiO₂ | 2 | 168 | 137 | 45 | 1.1 | 11.3 | 19.7 |
| | Nb₂O₅ | 1 | 315 | 10 | 3 | 1.1 | 23.9 | 10.7 |

FIGS. 3 and 4 are graphs of optical characteristics of the examples of the substrate 40 for the semi-transmitting type liquid crystal display element, shown in FIG. 2.

As shown in FIGS. 3 and 4, an example of the substrate 40 for the semi-transmitting type liquid crystal display element, which includes a multilayer film comprised of layers the number m of which is 3 or 4, has optical characteristics in which the transmittance of the substrate 40 for light with wavelengths of 400 to 750 nm in the visible light region is not less than 80%, more specifically, in a range of 80 to 90%, and the reflectance thereof for the light is not more than 20%, more specifically, in a range of 10 to 20%. According to the above optical characteristics, the difference between the maximum value and the minimum value of the transmittance, and the difference between the maximum value and the minimum value of the reflectance, in wavelength areas corresponding to red (640 nm), green (530 nm), and blue (460 nm) are all not more than 10%, with no ripple in the optical spectrum, which indicates flat characteristics of the substrate 40. This makes it possible to suppress occurrence of display non-uniformities of the color pigments 51 corresponding to red, green, and blue.

Further, an example of the substrate 40 for the semi-transmitting type liquid crystal display element, which includes a multilayer film comprised of layers the number m of which is 5 or 6, has optical characteristics in which the transmittance of the substrate 40 for light with wavelengths of 400 to 600 nm is in a range of 60 to 75% and the reflectance thereof for the light is in a range of 25 to 40%, and in which the transmittance thereof for light with wavelengths of 600 to 750 nm is in a range of 60 to 85% and the reflectance thereof for the light is in a range of 15 to 40%. This enables the substrate 40 including the multilayer film comprised of layers the number m of which is 5 or 6 to have a higher reflectance than that of the substrate 40 including the multilayer film comprised of layers the number m of which is 3 or 4.

Further, an example of the substrate 40 including a multilayer film comprised of layers the number m of which is in a range of 7 to 14 has optical characteristics in which the transmittance of the substrate 40 for light with wavelengths of 400 to 600 nm is in a range of 55 to 70% and the reflectance thereof for the light is in a range of 30 to 45%, and in which the transmittance thereof for light with wavelengths of 600 to 750 nm is in a range of 55 to 80% and the reflectance thereof for the light is in a range of 20 to 45%. This enables the substrate 40 including the multilayer film comprised of layers the number m of which is in a range of 7 to 14 to have a higher reflectance than that of the substrate 40 including the multilayer film comprised of layers the number m of which is 5 or 6.

Although in the above-described embodiment, the inline sputtering system is used, the carrousel-type sputtering system may be used.

Further, although in the above-described embodiment, the power applied to the targets is a DC, this is not limitative, but the power may be a high frequency (RF) of e.g. 13.56 MHz, or DC pulses for preventing arcing (abnormal discharge).

Further, although the DC sputtering method using a target of a conductive compound, such as conductive niobium pentoxide, is employed as the method of forming films of a high-refractive-index material, this is not limitative, but a reactive sputtering method using a target of a niobium element, and an RF sputtering method using a target of nonconductive i.e. insulative niobium pentoxide may be used. Out of the above film-forming methods, the DC sputtering method uses conductive niobium pentoxide higher in activation energy than the niobium element or the insulative niobium pentoxide, as the target, and hence it is possible to utilize a transition region of the target, whereby a higher film-forming speed can be attained than in the other film-forming methods, which contributes to enhanced manufacturing efficiency.

As the method of forming films of a low-refractive-index material, there may be employed a reactive DC sputtering method using a target of a conductive compound, such as conductive silicon dioxide.

Although in the present embodiment, the semi-transmitting type liquid crystal display element 100 is assumed to have a reflectance set to a value in the range of 45 to 80%, this is not limitative, but the liquid crystal display element may be a transmitting-type liquid crystal display element which has a reflectance set to a value in a range of 5 to 45%. The transmitting-type liquid crystal display element is mainly used under a darker environment than a reflecting-type liquid crystal display element having a reflectance set to a value in a range of not less than 90%. Therefore, the transmittance and the reflectance of the substrate 40 are set according to specifications (use, etc.) demanded of a design of the liquid crystal display element.

Further, in the above-described embodiment, a hydrophilic film, which contains silicon dioxide as a main component and has a film thickness of not larger than 10 nm, may be formed on the upper surface of the outermost layer of the reflective mirror 42. This makes it possible to easily wash the reflective mirror 42 with a water-soluble washing liquid.

Further, a foundation film mainly composed of silicon dioxide may be formed between the transparent substrate 41 and the high-refractive-index transparent film 43a. By forming the foundation film, it is possible to enhance adhesiveness between the transparent substrate 41 and the high-refractive-index transparent film 43a and prevent pollution caused by sodium ion leaching from the inside of soda lime silicate glass forming the transparent substrate 41. Further, it is preferable that when the transparent substrate 41 is formed by a transparent plastic substrate, hard coating made of polyorganosiloxanes is provided between the foundation film and the transparent substrate 41. This makes it possible to prevent moisture from leaching from the inside of the transparent substrate 41.

Furthermore, between the foundation film and the transparent substrate 41, there may be formed a transparent irregularity scattering layer which is made of a thermosetting resin, such as an acrylic resin, a polyimide resin, or an epoxy resin, and has minute irregularities formed on a surface thereof. This makes it possible to scatter reflected light passing through the inside of the transparent substrate 41 to thereby suppress glaring in appearance when the liquid crystal display element 100 is used. In this connection, it is preferable that the refractive index of the transparent irregularity scattering layer is approximately equal to that of the transparent substrate 41.

Next, a concrete example of the present invention will be described.

So as to suppress occurrence of display non-uniformity, the present inventors prepared an experimental specimen of the semi-transmitting type liquid crystal display element 100, and studied influence of the photocatalytic property of the high-refractive-index transparent films 43a and 43b on the semi-transmitting type liquid crystal display element 100.

More specifically, there were prepared the semi-transmitting type liquid crystal display element 100 (Example 1) which uses niobium pentoxide for the high-refractive-index transparent films 43a and 43b and includes a multilayer film comprised of layers the number m of which is 4, as shown in FIG. 1 and Table 1, and a liquid crystal display element (Comparative Example 1) which has the same construction as that of Example 1 but in which photocatalytically active titanium dioxide is used for high-refractive-index transparent films in place of niobium pentoxide. Then, adhesiveness between the reflective mirror and the color pigments was evaluated.

In Comparative Example 1 as well, the reflective mirror was formed by the same film-forming method as employed in Example 1 except that titanium dioxide was used for the high-refractive-index transparent films 43a and 43b.

Results of measurements of adhesiveness between the reflective mirrors and the color pigments in the liquid crystal display elements of Example 1 and Comparative Example 1 prepared as above are shown in Table 2.

TABLE 2

| | Adhesiveness between Reflective | | |
|---|---|---|---|
| | Mirror and Color Pigments | | Display |
| | During Irradiation | After Irradiation | Non-uniformity |
| Example 1 | Good | Good | Not Occurred |
| Comparative | Poor | Good | Occurred |
| Example 1 | | | |

In Table 2, “Adhesiveness between Reflective Mirror and Color Pigments” was evaluated by conducting a tape test in which a cellophane adhesive tape is affixed to the surface of the color pigments and peeled therefrom, during and after irradiation of light, whereby the adhesiveness at the interface between the reflective mirror and the color pigments of each of Example 1 and Comparative Example 1 was evaluated into four categories. In Table 2, the symbol “Good” indicates that no color pigments were peeled off the reflective mirror, and the symbol “Poor” indicates that peeling areas in which color pigments were peeled off the reflective mirror occupy 0 to 3% of the whole adhesive areas. Further, “Occurred” in “Display Non-uniformity” indicates that display non-uniformity occurred during irradiation of light, and “Not Occurred” indicates that there occurred no display non-uniformity during irradiation of light.

It is understood from Table 2 that when niobium pentoxide is used for the high-refractive-index transparent film in place of titanium dioxide, interactions between the high-refractive-index transparent films and resin components are reduced compared with the case of titanium dioxide being used, which enhances affinity and adhesiveness, and thereby makes it possible to improve adhesiveness between the high-refractive-index transparent films and the low-refractive-index transparent films, and accordingly improve adhesiveness between the reflective mirror and the color pigments. Further, it is also understood that when the outermost surface of the reflective mirror is formed as a high-refractive-index transparent film, adhesiveness between the reflective mirror and the color pigments can be further improved.

Further, it is understood from Table 2 that Example 1 is capable of suppressing occurrence of display non-uniformity during irradiation of light, which is caused by photo-induced charge separation due to the photocatalytic activity of the titanium dioxide of Comparative Example 1.

The substrate for a semi-transmitting type liquid crystal display element according to the embodiment of the present invention can be applied to semi-transmitting type liquid crystal display elements, transmitting-type liquid crystal display elements, and so forth.

What is claimed is:

1. A substrate for a semi-transmitting type liquid crystal display element, comprising:
a transparent substrate; and
a reflective mirror formed by alternately forming in layers at least one first transparent dielectric film and at least one second transparent dielectric film on said transparent substrate, said first and second transparent dielectric films being different in refractive index from each other,
wherein said reflective mirror is formed between a liquid crystal section of the semi-transmitting type liquid crystal display element and said transparent substrate, and
said first transparent dielectric film is made of a substantially photocatalytically inactive compound.

2. A substrate for a semi-transmitting type liquid crystal display element as claimed in claim 1, wherein the compound comprises niobium oxide.

3. A substrate for a semi-transmitting type liquid crystal display element as claimed in claim 2, wherein the niobium oxide comprises niobium pentoxide or an oxygen-deficient form thereof.

4. A substrate for a semi-transmitting type liquid crystal display element as claimed in claim 2, wherein the niobium oxide has a refractive index in a range of 2.2 to 2.5 for light with wavelengths of 400 to 800 nm.

5. A substrate for a semi-transmitting type liquid crystal display element as claimed in claim 1, wherein said first transparent dielectric film has a higher refractive index for light with wavelengths of 400 to 800 nm than that of said second transparent dielectric film, and a most remote surface of said reflective mirror from said transparent substrate is made of said first transparent dielectric film.

6. A substrate for a semi-transmitting type liquid crystal display element as claimed in claim 1, wherein said first transparent dielectric film has a higher refractive index for light with wavelengths of 400 to 800 nm than that of said second transparent dielectric film, said first transparent dielectric film being in contact with said transparent substrate.

7. A substrate for a semi-transmitting type liquid crystal display element as claimed in claim 1, wherein said first and second transparent dielectric films of said reflective mirror are formed in three or four layers, and
said reflective mirror has optical characteristics that transmittance thereof for light with wavelengths in a visible light region is not less than 80%, and reflectance thereof for the light is not more than 20%.

8. A substrate for a semi-transmitting type liquid crystal display element as claimed in claim 1, wherein said first and second transparent dielectric films of said reflective mirror are formed in five or six layers, and
said reflective mirror has optical characteristics that transmittance thereof for light with wavelengths of 400 to 600 nm is 60 to 75% and reflectance thereof for the light is 25 to 40%, and that transmittance thereof for light with wavelengths of 600 to 750 nm is 60 to 85% and reflectance thereof for the light is 15 to 40%.

9. A substrate for a semi-transmitting type liquid crystal display element as claimed in claim 1, wherein said first and second transparent dielectric films of said reflective mirror are formed in seven to fourteen layers, and
said reflective mirror has optical characteristics that transmittance thereof for light with wavelengths of 400 to 600 nm is 55 to 70% and reflectance thereof for the light is 30 to 45%, and that transmittance thereof for light with wavelengths of 600 to 750 nm is 55 to 80% and reflectance thereof for the light is 20 to 45%.

10. A semi-transmitting type liquid crystal display element, comprising the substrate for a semi-transmitting type liquid crystal display element as claimed in claim 1, and color pigments formed on said reflective mirror,
wherein said liquid crystal section is formed on said color pigments.

11. A semi-transmitting type liquid crystal display element as claimed in claim 10, wherein said first transparent dielectric film has a higher refractive index for light with wavelengths of 400 to 800 nm than that of said second transparent dielectric film, said first transparent dielectric film being in contact with said color pigments.

12. A semi-transmitting type liquid crystal display element as claimed in claim 10, formed either as a semi-transmitting type liquid crystal display element in which reflectance thereof for light with wavelengths of 400 to 800 nm is set to a range of 45 to 80%, or as a transmitting type liquid crystal display element in which reflectance thereof for the light with wavelengths of 400 to 800 nm is set to a range of 5 to 45%.
